(19) United States
(12) Patent Application Publication
(10) Pub. No.: US 2016/0086227 A1
(43) Pub. Date: Mar. 24, 2016

(54) METHODS FOR TRANSMITTING CONTENT TO WIRELESS DEVICES AND SYNCHRONIZED DISPLAYS OF THE SAME

(71) Applicant: Michael Sharp, Porter, TX (US)

(72) Inventor: Michael Sharp, Porter, TX (US)

(21) Appl. No.: 14/861,946

(22) Filed: Sep. 22, 2015

Related U.S. Application Data
(60) Provisional application No. 62/053,648, filed on Sep. 22, 2014.

(51) Int. Cl. G06Q 30/02

(52) U.S. Cl. CPC G06Q 30/0267

(57) ABSTRACT

Systems and methods are provided for delivering media content to users while other actions are pending, including pending telephone call connections.

### CROSS REFERENCE TO RELATED APPLICATION

This application claims the benefit of U.S. Provisional Application No. 62/053,648 filed Sep. 22, 2014, which is herein incorporated by reference in its entirety.

### FIELD

This disclosure is related to systems and methods for delivering media to users.

### BACKGROUND

As the use of smartphones and other similar devices has increased, the amount of screen time of users has similarly increased. In addition, there are many times when users are waiting for the transfer of information or events to their devices. Accordingly, it would be desirable to provide additional media to users while they are waiting for the transfer of information or events to their devices.

### SUMMARY

Various systems and methods are provided for delivering media content to users during the pendency of a connecting telephone call. In some embodiments, the media delivered during these “ring views” comprises advertisements with a variety of media.

In one embodiment, the method comprises one or more computer-readable media storing computer-executable instructions for causing a computer to perform a method of delivering media to a user while the user is initiating a separate action on a computing device. The method comprises receiving a request to connect the user, via a computing device with communication capabilities, to a second party, initiating a connection between the user and the second party, and transferring to the user, over a network, one or more advertisements while the connection is being initiated.

In other embodiments, the method further comprises storing the transferred advertisements for subsequent retrieval by the user after the connection between the user and second party is ended.

The act of transferring advertisements to the user can occur over a wi-fi network, or other network. The method can include transferring a video file to the user, transferring a graphic file to the user, or both. In other embodiments, the advertisement can be linked to the ability to download an app or quickly link to the website. In other embodiments, the advertisement provides a selectable option to receive a future contact regarding the subject of the advertisement.

In another embodiment, a method of delivering content during a ring view. The method includes receiving requests from a plurality of sponsors for providing advertising information to users and delivering predetermined media content to users during a pending telephone call.

The foregoing and other objects, features, and advantages of the invention will become more apparent from the following detailed description, which proceeds with reference to the accompanying figures.

### BRIEF DESCRIPTION OF THE DRAWINGS

FIG. 1 is a conventional view of a screenshot of a smartphone, showing the display of conventional information while waiting to connect to a telephone call.

FIG. 2 is a screenshot of a smartphone, showing the display of a logo as part of an advertisement while other content or action is being delivered or transferred to the smartphone.

FIG. 3 is a screenshot of a smartphone, showing an advertisement displayed while other content or action is being delivered or transferred to the smartphone.

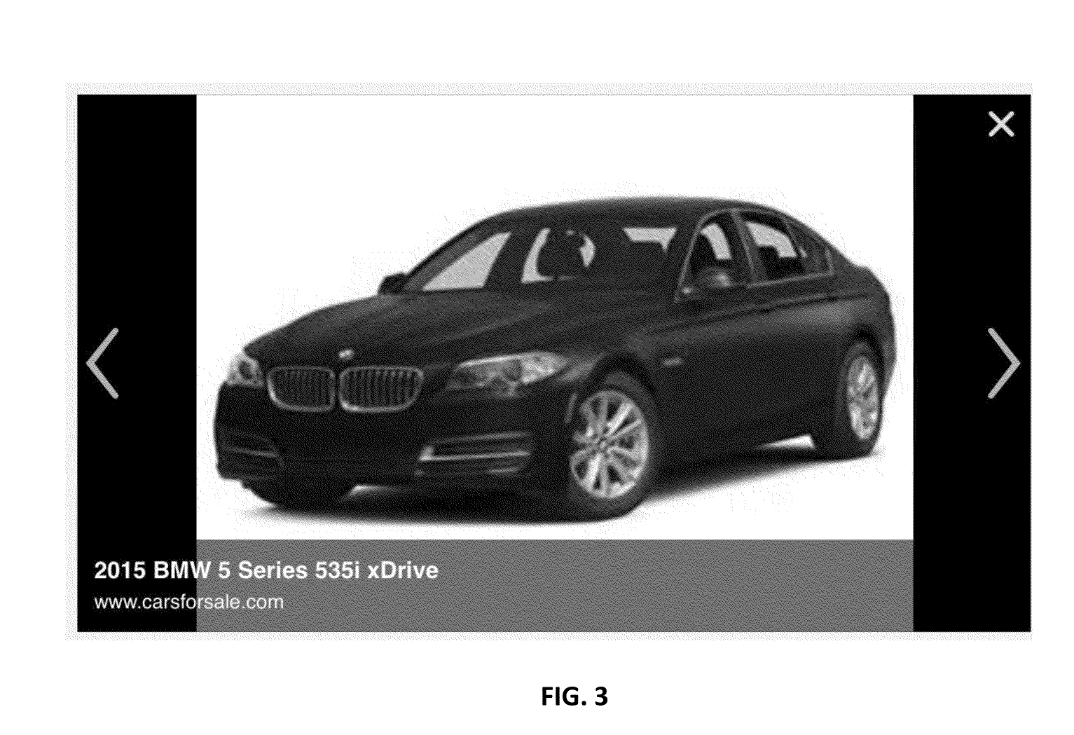

### DETAILED DESCRIPTION

For purposes of this description, certain aspects, advantages, and novel features of the embodiments of this disclosure are described herein. The disclosed methods, apparatuses, and systems should not be construed as limiting in any way. Instead, the present disclosure is directed toward all novel and nonobvious features and aspects of the various disclosed embodiments, alone and in various combinations and sub-combinations with one another. The methods, apparatuses, and systems are not limited to any specific aspect or feature or combination thereof, nor do the disclosed embodiments require that any one or more specific advantages be present or problems be solved.

Although the operations of some of the disclosed methods are described in a particular, sequential order for convenient presentation, it should be understood that this manner of description encompasses rearrangement, unless a particular ordering is required by specific language. For example, operations described sequentially may in some cases be rearranged or performed concurrently. Moreover, for the sake of simplicity, the attached figures may not show the various ways in which the disclosed methods can be used in conjunction with other methods. Additionally, the description sometimes uses terms like “determine” and “provide” to describe the disclosed methods. These terms are high-level abstractions of the actual operations that are performed. The actual operations that correspond to these terms may vary depending on the particular implementation and are readily discernible by one of ordinary skill in the art.

As used herein, the terms “a”, “an” and “at least one” encompass one or more of the specified element. That is, if two of a particular element are present, one of these elements is also present and thus “an” element is present. The terms “a plurality of” and “plural” mean two or more of the specified element. As used herein, the term “and/or” used between the last two of a list of elements means any one or more of the listed elements. For example, the phrase “A, B, and/or C” means “A,” “B,” “C,” “A and B,” “A and C,” “B and C” or “A, B and C.”

Various systems for providing media to users while other actions are pending, such as connecting to a telephone call. In some embodiments, these systems—including the transfer of media—may be implemented or performed, at least in part, by software stored on one or more tangible computer-readable media (e.g., one or more optical media discs, volatile memory or storage components (such as DRAM or SRAM), or nonvolatile memory or storage components (such as hard drives)) and executed on one or more computing systems. Some basic background information relating to computing systems capable of transferring files as discussed above are provided.

The transfer of information can be performed over local area networks, client-server networks, or other such networks. The devices receiving the media can be smartphones or other similar computing devices capable of receiving and displaying media content. These computing device can include one or more computing units having a processing unit and a system memory. The processing unit may be any type of programmable electronic device for executing software instructions, but will conventionally be a microprocessor. The system memory may include a read-only memory (“ROM”) and/or a random access memory (“RAM”). As will be appreciated by those of ordinary skill in the art, either or both of the ROM or the RAM may store software instructions for execution by the processing unit.

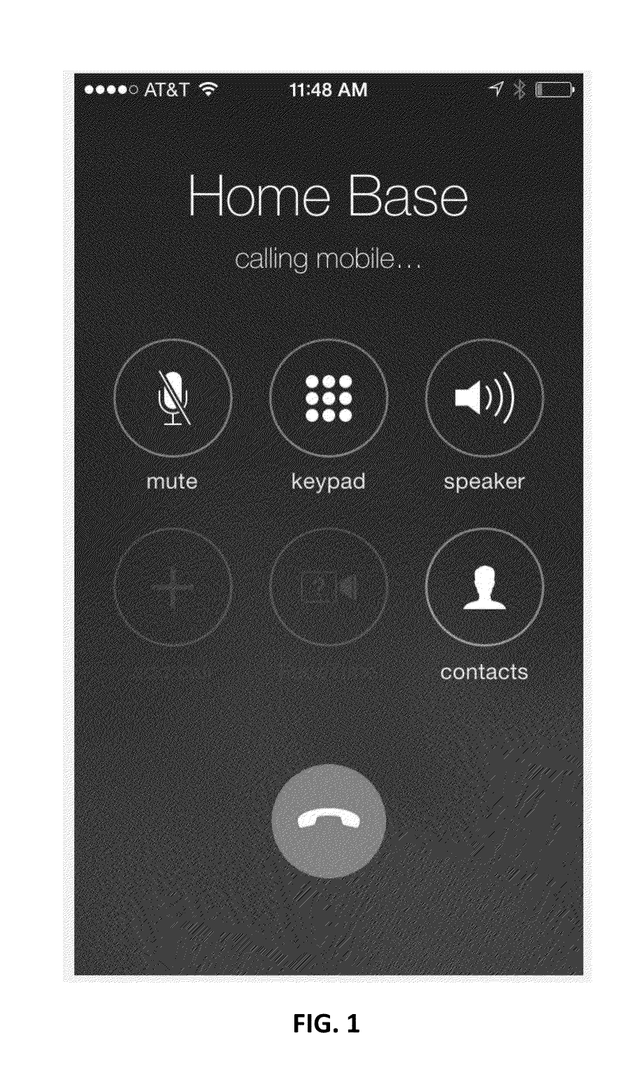

In one embodiment, the system and methods can provide improvements over conventional technology, such as that shown in FIG. 1. FIG. 1 illustrates a conventional screen view while a user is waiting to connect to a telephone call. During that time the user is otherwise attentive and viewing the screen. Accordingly, it would be advantageous to use that screen viewing time effectively. This display screen while waiting to a call is referred to herein as the “ring view.”

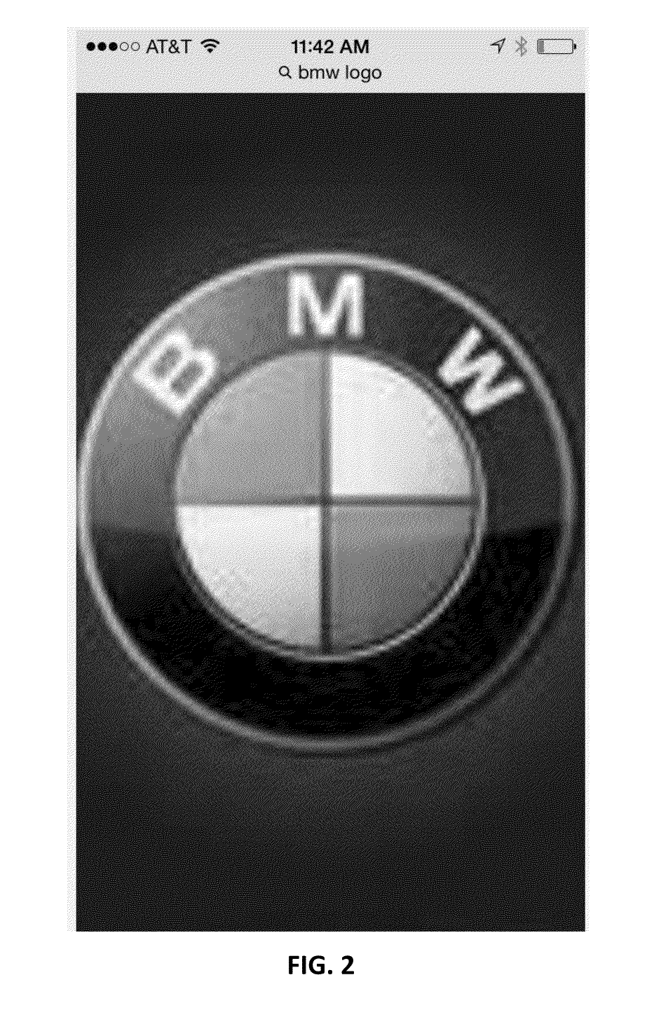

FIG. 2 illustrate an example of a ring view that could be provided to user during a period while the user is waiting for a call to connect. Thus, for example, an advertisement can be provided for any company's services or products (e.g., BMW) during that time period.

The media transferred while waiting for the call to connect can comprise any type of media, including for example, audio, logo, text, video, and/or some combination of these. In some embodiments, the ad can change each time a ring occurs creating greater value and ultimately higher payouts for ring view campaigns.

In some embodiments, the media delivery can be synchronized with rings. That is, media that is displayed during a first ring can change during the second ring. By synchronizing media in this manner, the waiting associated with rings can be synchronized to present media in a manner that provides the user with a sense of timing similar to that of a ring tone. Of course, the media can change to different media between rings (e.g., different ads) or it can be different video, sounds, or other images associated with the same ad.

To provide more targeted advertisements, campaigns can take into account live target data including location geographical location of the user, time of call, caller network, etc. For example, an ad server can use a geographic location as a determining factor as to which ad will display and present ads that are location specific.

In some embodiments, ad networks can bid for right to display. For example, particular time or locations can be particularly valuable to advertisers, and these periods or locations can be made available by bidding for these time/location based campaigns.

In other embodiments, the calling can take place over wi-fi calling networks and the delivery of media can be made over wi-fi networks. This may allow for faster transfer speeds, resulting in the ring view to be provided either more quickly, with more content, or both.

In another embodiment, the media that is delivered can comprise an offer to download or install an app or be transferred to a sponsor's web site for more information about the sponsor or the sponsor's services or products.

In another embodiment, an option can be provided that allows the user to select or choose to have the sponsor deliver a personal call to the user in the future. Thus, for example, the user could touch the screen and choose an option like “CALL ME BACK!” or “YES, I'M INTERESTED—SEND ME MORE INFORMATION.”

In other embodiments, the user could review ad images by touching the phone screen after the call has connected to the original party caller. Thus, if the user is interested but did not have enough time to consider the media delivered during the period the caller was waiting, the user could review the media at a later time. Alternatively, media associated with the ads can remain on the screen after the call has been answered.

In some embodiments, the user's own media can be used to provide media content during a holding period. For example, the user can select media (either already stored on the device or available through another server) that can playback during a holding period. In this manner, instead of listening to “on-hold” music, the user can listen and/or watch media of his or her own choosing.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. I therefore claim as my invention all that comes within the scope of these claims.

I claim:

1. One or more computer-readable media storing computer-executable instructions for causing a computer to perform a method of delivering media to a user while the user is initiating a separate action on a computing device, the method comprising:
receiving a request to connect the user, via a computing device with communication capabilities, to a second party;
initiating a connection between the user and the second party; and
transferring to the user, over a network, one or more advertisements while the connection is being initiated.

2. The one or more computer-readable media of claim 1, wherein the method further comprises storing the transferred advertisements for subsequent retrieval by the user after the connection between the user and second party is ended.

3. The one or more computer-readable media of claim 1, wherein the act of transferring advertisements to the user occurs over a wi-fi network.

4. The one or more computer-readable media of claim 1, wherein the method further comprises transferring a video file to the user.

5. The one or more computer-readable media of claim 1, wherein the method further comprises transferring a graphic file to the user.

6. The one or more computer-readable media of claim 1, wherein the advertisement is linked to the ability to download an app.

7. The one or more computer-readable media of claim 1, wherein the advertisement is linked to a website, and the user can quickly link to the website.

8. The one or more computer-readable media of claim 1, wherein the advertisement provides a selectable option to receive a future contact regarding the subject of the advertisement.

9. A method of delivering content during a ring view, the method comprising:
receiving requests from a plurality of sponsors for providing advertising information to users; and
delivering predetermined media content to users during a pending telephone call.

10. The method of claim 9, wherein the delivering of predetermined media content comprises delivering a first media for playback during a first ring and a second media for playback during a second ring.

11. The method of claim 10, wherein the first and second media are different advertisements.

12. The method of claim 10, wherein the first and second media are synchronized to occur with the first and second rings, respectively.
